(19) United States
(12) Patent Application Publication
(10) Pub. No.: US 2017/0152666 A1
(43) Pub. Date: Jun. 1, 2017

(54) RIGID SURFACE COVERING PLASTIC MATERIAL

(71) Applicant: Shanghai Jinka Flooring Technology Co., LTD., Shanghai City (CN)

(72) Inventors: WANPENG LI, Shanghai City (CN); NAN YE, Shanghai City (CN)

(21) Appl. No.: 15/015,138

(22) Filed: Feb. 4, 2016

(30) Foreign Application Priority Data
Dec. 1, 2015 (CN) 201510872395.9

(51) Int. Cl. E04F 15/10; E04F 15/02; C08L 27/06

(52) U.S. Cl. CPC E04F 15/107; C08L 27/06; E04F 15/02038; E04F 15/102; C08L 2205/06

(57) ABSTRACT

A rigid surface covering plastic material includes a base layer which including 100 wt % of PVC resin, 10˜60 wt % of solid plasticizer and 60˜510 wt % of additive. The solid plasticizer is selected from a group consisting of a modified green plastic with a melting point of 50˜150° C. and EPDM. The stiffness of the rigid surface covering plastic material is significantly improved by adding solid plasticizers into the material mixture of the base layer and providing a reasonable formula design of the material mixture, and due to the melting points of the solid plasticizers below a calender processing point of the PVC, the fluidity of molten PVC mixture is improved, and calender molding of the molten PVC mixture is facilitated.

### CROSS REFERENCE TO RELATED APPLICATION

The present application is based on and claims priority of Chinese Patent Application No. 201510872395.9, filed on Dec. 1, 2015. The entire disclosure of the above-identified application, including the specification, drawings and claims are incorporated herein by reference in its entirety.

### FIELD OF THE INVENTION

The present invention relates to a decorative building material, and more particularly to a rigid surface covering plastic material.

### BACKGROUND OF THE INVENTION

Indoor decorative flooring tiles generally include hardwood flooring, stone flooring, rubber flooring, linoleum flooring, and composite flooring which generally includes composite wood, wood-plastic composites, and PVC tiles. Owing to utilize fiber as substrate material, the hardwood flooring, the composite wood and the linoleum flooring have the defects of poor water proofing property and easy deformation. The stone flooring has the defects of poor thermal insulation property and slippery, especially in rainy season, individuals are easy to slip and get injured because of the slippery surface of the stone flooring. The rubber flooring has excellent overall performance except high price and strict installation requirement, which limits its usage and expansion. In addition, the stone flooring and the rubber flooring are quite heavy for transportation and installation, especially for high buildings, it will cause harmful damages to the main frames. Wood-plastic flooring is a kind of green flooring with excellent properties, however, its internal stress can not be eliminated completely and the flooring is liable to deform and crack as time goes by or temperature and humidity changes. Furthermore, due to the wood-plastic flooring is easy deformation under pressure, it is easy to produce unrecoverable indentation during transportation.

PVC tiles occupy the largest market share in the composite flooring market due to its excellent waterproof, fire retardant and wear resistance properties, and have advantages of color diversity, beautiful and durable, simple installation and low replacement cost. However, the flooring usually applies locking structure under a consideration of environment protection and easy installation. The locking force of the locking structure depends primarily on connections between projections and recesses of the locking structure, and is generally determined by the structure, the machining precision, and the substrate material of the locking structure. Due to the substrate material of the current available PVC tiles is relative soft, the locking structure of the current available PVC tiles can easily be opened, making the flooring be easily warped or fallen off after a period of installation. In order to increase connection strengths of the PVC tiles, commonly used methods include: lengthening the locking structure, utilizing complex locking structures and improving machining precision of the locking structures. Although the forgoing methods could increase the connection strengths of the PVC tiles, they generally have two defects: the first is time-consuming and laborious installation, and the second is the increase of the PVC tiles cost.

In addition, there is a kind of PVC foam flooring in the market. This kind of flooring has moderate hardness and suitable for processing locking structures, however, this kind of flooring are usually manufactured by extrusion molding, which leads the flooring be low productivity and have poor dimensional stability, and be not suitable for mass production.

In order to overcome the forgoing defects, it is necessary to develop a kind of PVC tiles with good machining property, relative high hardness, strong toughness, and acceptable cost.

### SUMMARY OF THE INVENTION

The object of the present invention is to provide a rigid surface covering plastic material.

The present invention provides a rigid surface covering plastic material including a base layer which includes 100 wt % of PVC resin, 10˜60 wt % of solid plasticizer and 60˜510 wt % of additive. The solid plasticizer is selected from a group consisting of a modified green plastic with a melting point of 50˜150° C. and EPDM.

In an embodiment of the present invention, the base layer further includes 0.1˜10 wt % of liquid plasticizer.

In an embodiment of the present invention, the base layer includes 30˜60 wt % of the solid plasticizer.

In an embodiment of the present invention, the modified green plastic with a melting point of 5˜150° C. is selected from a group consisting of modified TPU, modified PU and modified PP.

In an embodiment of the present invention, the solid plasticizer is a modified TPU with a melting point of 120˜130° C.

In an embodiment of the present invention, the base layer includes 150˜350 wt % of the additives.

In an embodiment of the present invention, the base layer includes 225˜300 wt % of the additives.

In an embodiment of the present invention, the liquid plasticizer is selected from a group consisting of phthalate acid esters plasticizers, fatty acid ester plasticizers, aliphatic dibasic acid ester plasticizers, phosphate ester plasticizers, epoxy compound plasticizers, chlorine-containing plasticizers and trimellitate plasticizers.

In an embodiment of the present invention, the liquid plasticizer is DOTP.

In an embodiment of the present invention, the base layer includes a middle layer and a bottom layer, the middle layer includes 100 wt % of PVC resin, 10˜60 wt % of solid plasticizer and 125˜400 wt % of additive, the bottom layer includes 100 wt % of PVC resin, 10˜60 wt % of solid plasticizer and 60˜350 wt % of additive.

In an embodiment of the present invention, the rigid surface covering plastic material further includes at least a glass fiber layer, which is disposed between the middle layer and the bottom layer.

In an embodiment of the present invention, the middle layer has multilayer structure; the rigid surface covering plastic material further includes at least a glass fiber layer, which is disposed between adjacent layers of the middle layer.

In an embodiment of the present invention, the rigid surface covering plastic material further includes a decoration layer disposed on the base layer and a surface protection layer disposed on the decoration layer, the surface protection layer is a hard PVC transparent film or a hard transparent polyester film.

In an embodiment of the present invention, a hardness of the surface protection layer is 50˜85 HD, and a thickness of the surface protection layer is 0.05˜1.5 mm

In an embodiment of the present invention, a rigid surface covering plastic material sheet with a thickness of 2.0˜7.0 mm droops a distance of less than 100 mm within two hours at room temperature and the stiffness of the rigid surface covering plastic material is measured by the droop distance of the rigid surface covering plastic material sheet.

In an embodiment of the present invention, the dimension of the rigid surface covering plastic material sheet used for measuring the stiffness of the rigid surface covering plastic material is 457.2 mm*50 mm, when measuring, the rigid surface covering plastic material sheet is placed on a work table of 100 mm high with a first end of 165 mm length laying on the work table and a second end extending outside the work table, the first end of the rigid surface covering plastic material sheet is pressed a length of 50 mm at a position spacing a distance of 115 mm from a corresponding terminal end of the work table.

The present invention provides a rigid surface covering plastic material including a base layer which includes PVC resin, solid plasticizer and additive. The solid plasticizer is selected from a group consisting of a modified green plastic with a melting point of 50˜150° C. and EPDM. The stiffness of the rigid surface covering plastic material is measured by a droop distance of a rigid surface covering plastic material sheet with a thickness of 2.0˜7.0 mm, and the rigid surface covering plastic material sheet droops a distance of less than 100 mm within two hours at room temperature.

In an embodiment of the present invention, the base layer of the rigid surface covering plastic material includes 100 wt % of PVC resin, 10˜60 wt % of solid plasticizer and 60˜510 wt % of additive.

In the present invention, the stiffness of the rigid surface covering plastic material is significantly improved by adding solid plasticizers (a modified green plastic with a melting point of 50˜150° C. and/or EPDM) into the material mixture of the base layer and providing a reasonable formula design of the material mixture. Due to the melting points of the modified green plastic and EPDM are below a calender processing point 160˜170° C. of PVC, the fluidity of molten PVC mixture is improved, and calender molding of the molten PVC mixture is further facilitated.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a rigid surface covering plastic material according to a first embodiment of the present invention.

FIG. 2 is a schematic view of a rigid surface covering plastic material according to a third embodiment of the present invention.

FIG. 3 is a schematic view of a locking structure of a rigid surface covering plastic material according to a fourth embodiment of the present invention.

FIG. 4 is a schematic view of a work table used for measuring a stiffness of the rigid surface covering plastic material of the present invention.

FIG. 5 is a schematic view showing the location of a test piece on the work table.

FIG. 6 is a schematic view showing one end of the test piece being pressed by a pressing block.

FIG. 7 is a schematic view showing a droop state of the test piece.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### Embodiment 1

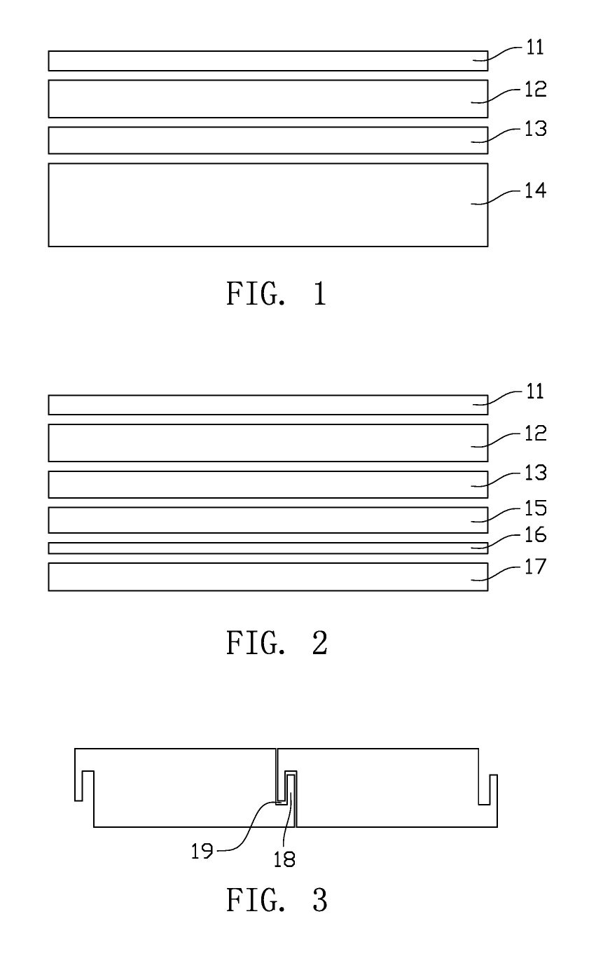

The rigid surface covering plastic material of the present invention is preferably PVC tiles, which can be used to cover ceiling, wall, and wardrobe as well as ground. Referring to FIG. 1, the rigid surface covering plastic material includes a UV coating layer 11, a surface protection layer 12, a decoration layer 13 and a base layer 14 sequentially from top to bottom.

The UV coating layer 11 is formed on the surface protection layer 12 and the UV coating layer 11 could be omitted in other embodiments of the present invention.

The surface protection layer 12 can be made of hard PVC transparent film, hard transparent polyester film or other suitable materials, and having a thickness of 0.05˜1.5 mm. A hardness of the hard PVC transparent film or the hard transparent polyester film is 50˜85 HD (shore hardness unit). If the surface protection layer 12 is made of hard PVC transparent film or hard transparent polyester film, its hardness influences the total stiffness of the rigid surface covering plastic material. If the surface protection layer 12 is made of non-hard material, the hardness of the surface protection layer 12 is negligible. In the present embodiment, the surface protection layer 12 is made of hard PVC transparent film or hard transparent polyester film.

The decoration layer 13 is a PVC film or a polyester film with printed patterns or textures formed on a surface thereof. In a preferred embodiment, both of the surface protection layer 12 and the decoration layer 13 are PVC layer. In the present invention, the thickness and the hardness of the UV coating layer 11 and the decoration layer 13 are negligible.

The base layer 14 of a single layer or multilayer formed by rolling a mixture including PVC resin, solid plasticizer, liquid plasticizer and additive. In the present embodiment, the base layer 14 is a single layer. A thickness of the base layer 14 is in the range of 1.95˜6.95 mm.

The material of the base layer 14 includes 100 wt % of PVC resin, 10˜60 wt % of solid plasticizer (preferably 30˜60 wt %), 0.1˜10 wt % of liquid plasticizer, and 60˜510 wt % of additive (preferably 150˜350 wt % and 225˜300 wt % is best). That is, when preparing the material of the base layer 14, 100 parts of PVC resin is mixed with 10˜60 parts of solid plasticizer, 0.1˜10 parts of liquid plasticizer and 60˜510 parts of additive.

In the material of the base layer 14, the liquid plasticizer is selected from a group consisting of phthalate acid esters plasticizers, fatty acid ester plasticizers, aliphatic dibasic acid ester plasticizers, phosphate ester plasticizers, epoxy compound plasticizers, chlorine-containing plasticizers and trimellitate plasticizers. In the present embodiment, the liquid plasticizer is DOTP (dioctyl terephthalate). The solid plasticizer is a modified green plastic with a melting point of 50˜150° C., such as modified TPU (Thermoplastic polyurethanes), modified PU (Poly urethane), and/or modified PP (Polypropylene). In the present embodiment, the solid plasticizer is preferably modified TPU with a melting point of 120˜130° C. Furthermore, in another preferred embodiment, the solid plasticizer can also be EPDM (Ethylene Propylene Diene Monomer) or a mixture of EPDM and the modified green plastic with a melting point of 50˜150° C. In the present invention, the additive is a mixture of calcium carbonate powder and other additives. In the present invention, the other additives may be selected from a group consisting of stabilizers, flame retardants, smoke suppressants, antioxidants and other common additives.

In surface covering plastic material areas, the liquid plasticizers are commonly used, and the stiffness of the rigid surface covering plastic material is significantly improved by adding solid plasticizers (a modified green plastic with a melting point of 50˜150° C. and/or EPDM) into the material mixture of the base layer and providing a reasonable formula design of the material mixture. Due to the melting points of the modified green plastic and EPDM are below a calender processing point 160˜170° C. of PVC, the fluidity of molten PVC mixture is improved, and calender molding of the molten PVC mixture is further facilitated. In a preferred embodiment of the present invention, due to the modified TPU and EPDM has strength and toughness as rubber body, the strength and toughness of the rigid surface covering plastic material are significantly improved. Furthermore, due to the modified TPU and EPDM have low glass transition temperature (the minimum glass transition temperature of modified TPU reaches −50° C., and the minimum glass transition temperature of EPDM reaches −48° C.), the glass transition temperature of the PVC mixture is effectively reduced, and the rigid surface covering plastic material obtains good low temperature performance, which makes the rigid surface covering plastic material, especially PVC tiles, overcomes low temperature embrittlement defect, so that the product surface of the PVC tiles will not crack or fracture because of temperature difference between the origin country and the export country when exported to high-latitudes countries in Europe. In addition, owing to the thermal expansion coefficient of TPU is less than PVC, the sheet formed by the PVC mixture obtains better dimensional stability.

### Embodiment 2

In the present embodiment, the rigid surface covering plastic material includes the same UV coating layer 11, surface protection layer 12 and decoration layer 13 as the rigid surface covering plastic material of the first embodiment. The difference between the rigid surface covering plastic material of the present embodiment and the first embodiment is the base layer 14. In the present embodiment, the material of the base layer 14 does not include liquid plasticizer. In the present embodiment, the material of the base layer 14 includes: 100 wt % of PVC resin, 10˜60 wt % of solid plasticizer (preferably 30˜60 wt %), and 60˜510 wt % of additive (preferably 150˜350 wt % and 225˜300 wt % is best).

In the material of the base layer 14, the additive is a mixture of calcium carbonate powder and other additives. In the present invention, the other additives may be selected from a group consisting of stabilizers, flame retardants, smoke suppressants, antioxidants and other common additives. The solid plasticizer is a modified green plastic with a melting point of 50˜150° C., such as modified TPU (Thermoplastic polyurethanes), modified PU (Poly urethane), and/or modified PP (Polypropylene). In the present embodiment, the solid plasticizer is preferably modified TPU with a melting point of 120˜130° C. Furthermore, in another preferred embodiment, the solid plasticizer can also be EPDM (Ethylene Propylene Diene Monomer) or a mixture of EPDM and the modified green plastic with a melting point of 50˜150° C.

In the present embodiment, the stiffness of the rigid surface covering plastic material is significantly improved by changing the commonly used plasticizer, i.e. the liquid plasticizer, to the solid plasticizer, i.e., the modified green plastic with a melting point of 50˜150° C. and/or EPDM, and providing a reasonable formula design of the material mixture. Furthermore, Due to the melting points of the modified green plastic and EPDM are below a calender molding point 160˜170° C. of PVC, the fluidity of molten PVC mixture is improved, and calender molding of the molten PVC mixture is further facilitated. In a preferred embodiment of the present invention, due to the modified TPU and EPDM has strength and toughness as rubber body, the strength and toughness of the PVC sheet are significantly improved. Moreover, due to the modified TPU and EPDM have low glass transition temperature (the minimum glass transition temperature of modified TPU reaches −50° C., and the minimum glass transition temperature of EPDM reaches −48° C.), the glass transition temperature of the PVC mixture is effectively reduced, and the PVC tiles obtains good low temperature performance, and overcomes low temperature embrittlement defect, so that the product surface of the PVC tiles will not crack or fracture because of temperature difference between the origin country and the export country when exported to high-latitudes countries in Europe. In addition, owing to the thermal expansion coefficient of TPU is less than PVC, the sheet formed by the PVC mixture obtains better dimensional stability.

### Embodiment 3

In the present embodiment, as shown in FIG. 2, the rigid surface covering plastic material includes the same UV coating layer 11, surface protection layer 12 and decoration layer 13 as the rigid surface covering plastic material of the first embodiment. The difference between the rigid surface covering plastic material of the present embodiment and the first embodiment is the base layer. In the present embodiment, the base layer includes two layers, i.e., a middle layer 15 and a bottom layer 17. The components of the middle layer 15 and the bottom layer 17 are the same as the material of the base layer of the first embodiment, the difference is the proportion of the components. In the present embodiment, the middle layer 15 includes 100 wt % of PVC resin, 10˜60 wt % of solid plasticizer, 0.1˜10 wt % of liquid plasticizer and 125˜400 wt % of additive (preferably 150˜350 wt % and 225˜300 wt % is best). In the material of the middle layer 15, the additive is a mixture of calcium carbonate powder and other additives. The solid plasticizer is a modified green plastic with a melting point of 50˜150° C., such as modified TPU (Thermoplastic polyurethanes), modified PU (Poly urethane), and/or modified PP (Polypropylene). In the present embodiment, the solid plasticizer is preferably modified TPU with a melting point of 120˜130° C. Furthermore, in another preferred embodiment, the solid plasticizer can also be EPDM (Ethylene Propylene Diene Monomer) or a mixture of EPDM and the modified green plastic with a melting point of 50˜150° C. The middle layer 15 may be a single layer or include a multilayer structure. When the middle layer 15 has multilayer structure, at least a glass fiber layer may be arranged between adjacent layers of the middle layer, which increases the toughness, reduces deformation and increases stability of the rigid surface covering plastic material.

The bottom layer 17 includes 100 wt % of PVC resin, 10˜60 wt % of solid plasticizer, 0.1˜10 wt % of liquid plasticizer and 60˜350 wt % of additive (preferably 120˜300 wt % and 150˜250 wt % is best). In the material of the bottom layer 17, the additive is a mixture of calcium carbonate powder and other additives. The solid plasticizer is a modified green plastic with a melting point of 50˜150° C., such as modified TPU (Thermoplastic polyurethanes), modified PU (Poly urethane), and/or modified PP (Polypropylene). In the present embodiment, the solid plasticizer is preferably modified TPU with a melting point of 120˜130° C. Furthermore, in another preferred embodiment, the solid plasticizer can also be EPDM (Ethylene Propylene Diene Monomer) or a mixture of EPDM and the modified green plastic with a melting point of 50˜150° C.

In the present embodiment, at least a glass fiber layer 16 is arranged between the middle layer 15 and the bottom layer 17, for increasing the toughness, reducing deformation and increasing stability of the rigid surface covering plastic material. In the present invention, the influence of the glass fiber layer 16 on the thickness and the stiffness of the rigid surface covering plastic material are negligible. In other embodiments of the present invention, the glass fiber layer 16 can be omitted as appropriate.

### Embodiment 4

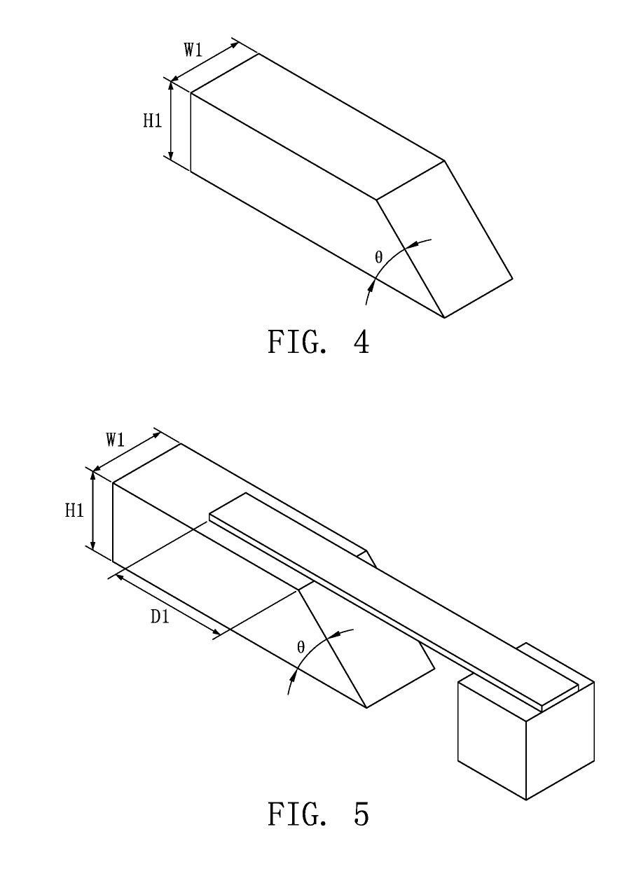

The rigid surface covering plastic material of the present embodiment is the same as that of the third embodiment. Both of the rigid surface covering plastic material of the present embodiment and the third embodiment include the UV coating layer 11, the surface protection layer 12, the decoration layer 13, the middle layer 15, the glass fiber layer 16 and the bottom layer 17. In the present embodiment, a plurality of locking structures are formed on the rigid surface covering plastic material. As shown in FIG. 3, one side of the rigid surface covering plastic material has recesses 18, and an opposite side of the rigid surface covering plastic material has projections 19. The projections 19 and the recesses 18 are clasped together to form a locking structure, which snaps adjacent PVC tiles together. Since the stiffness of the present invention is relative high, the present rigid surface covering plastic material overcomes the difficult installation problems caused by deformation of the ordinary PVC sheet since the material of the ordinary PVC sheet is relative soft. Furthermore, the stiffness of the rigid surface covering plastic material being relative high makes the rigid surface covering plastic material have good processing performance and good anti-crack performance (projections and recesses of brittle material are easy to generate irreparable crack during transportation), which effectively increases the locking force of the PVC sheet, on one side makes the locking force of the present rigid surface covering plastic material be greater than the locking force of the ordinary PVC sheet when they have the same type of locking structure, on the other side makes areas of the recesses and the projections of the present rigid surface covering plastic material be smaller than the ordinary PVC sheet in order to achieve the same locking force when they have the same type of locking structure. That is, the present rigid surface covering plastic material could decrease the areas of the locking structure and decreases the cost of the floor tile.

The above descriptions illustrate the specific embodiments of the rigid surface covering plastic material of the present invention, hereinafter; a method for measuring stiffness of the rigid surface covering plastic material of the present invention will be given. Because Shore A method and Shore D method, which are commonly used to measure hardness of a resilient sheet, can only measure surface hardness of a sheet, and surface hardness could be improved by coating hard painting, which results Shore hardness method could not reflect the real stiffness of the material, therefore, applicants provide a method for measuring the stiffness of the material of the sheet. According to the method, the rigid surface covering plastic material of the present invention droops a distance of less than 100 mm within two hours at room temperature. The method is given as follows:

Step one: Preparing samples. Preparing three pieces of test samples, the dimension of the sample is 457.2 mm*50 mm.

Step two: Preparing work table. As shown in FIG. 4, preparing a work table with a smooth top surface and a height H1 of 100 mm. The word table is shaped to have a right-angled trapezoid front view, a rectangular top view and a square side view. An acute angle θ of the right-angled trapezoid is 45°, and a side length of the square is 100 mm

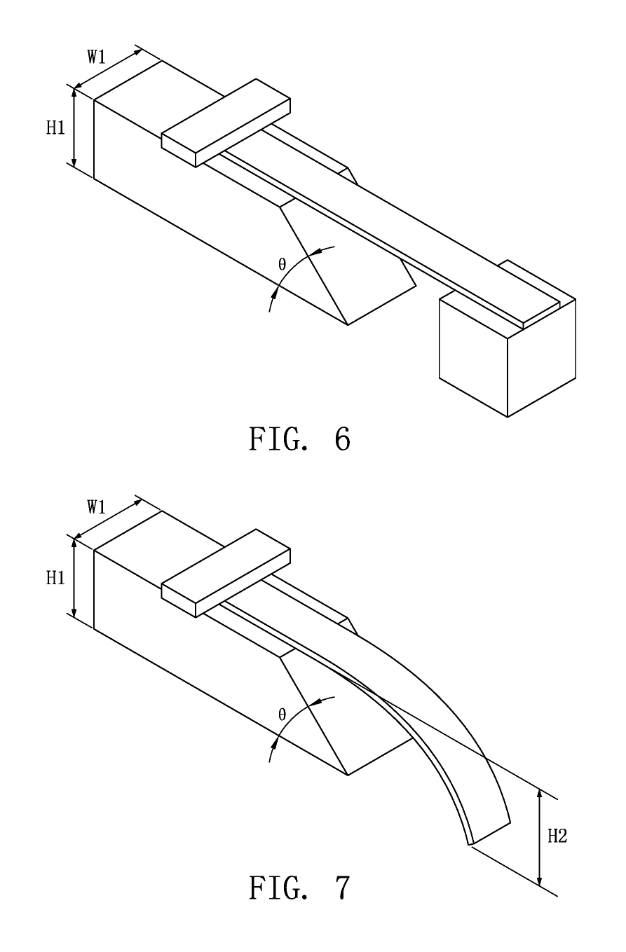

Step Three: placing the test piece on the work table with a free end of the test piece extending outside the work table, supporting the free end of the test piece by a support member and keeping the test piece at room temperature for a predetermined time to make performance of the whole test piece at a state be equivalent to the performance of the test piece under room temperature. Specifically shown in FIG. 5, the test piece is placed on the work table with a first end of the test piece lying on the work table and an opposite second end of the test piece extending outside the work table. A length D1 of the test piece on the work table (i.e., a length of the first end of the test piece) is 165 mm and a length of the test piece extending outside the work table (i.e., a length of the second end of the test piece) is 292.2 mm. The second end of the test piece is supported by a support member with a dimension of 100 mm*100 mm*100 mm and the test piece is kept at a temperature of 23±1°C. for more than 24 hours.

Step four: putting a pressing block on the work table and pressing on the first end of the test piece. Specifically shown in FIG. 6, the pressing block is placed on the work table at a position spacing a slant surface of the work table a distance D2 of 115 mm and pressing on the first end of the test piece a length of 50 mm

Step Five: removing the support member and starting to test. As shown in FIG. 7, starting the time at the moment the support member being removed until the test piece touchdown. The stiffness of the test piece can be measured by the time the test piece spent to touchdown. The longer the time spent, the greater stiffness the test piece has. That is, the shorter the time spent, the smaller stiffness the test piece has, which represents the test piece be softer. Because the time the first end of the test piece spent to touchdown is more than two hours, a droop distance of the first end of the test piece could be used to measure the stiffness of the test piece. The data of the droop distance of the first end of the test piece within two hours is obtained by measuring the droop distances of the first ends of the test pieces within two hours and taking an average of three sets of data.

It should be noted that the method is for measuring rigid surface covering plastic material sheets with a thickness from 2.0˜7.0 mm, an absolute deviation of the test results should be less than or equal to 10%, otherwise the sample is considered failure, and need to re-sample and test.

The following experiment data is taken to verify the stiffness a rigid surface covering plastic materials of the present invention. The samples were taken for collection of the test data are as follows:

Sample 1: a rigid surface covering plastic material includes a UV coating layer, a surface protection layer, a decoration layer, a middle layer, a glass fiber layer and a bottom layer, wherein the middle layer includes 100 wt % of PVC resin, 10˜60 wt % of solid plasticizer, 0.1˜10 wt % of liquid plasticizer and 150˜350 wt % of additive, the bottom layer includes 100 wt % of PVC resin, 10˜60 wt % of solid plasticizer, 0.1˜10 wt % of liquid plasticizer and 120˜300 wt % of additive.

Sample 2: a rigid surface covering plastic material includes a UV coating layer, a surface protection layer, a decoration layer, a middle layer, a glass fiber layer and a bottom layer, wherein the middle layer includes 100 wt % of PVC resin, 10˜60 wt % of solid plasticizer, 0.1˜10 wt % of liquid plasticizer and 225˜300 wt % of additive, the bottom layer includes 100 wt % of PVC resin, 10˜60 wt % of solid plasticizer, 0.1˜10 wt % of liquid plasticizer and 150˜250 wt % of additive.

Sample 3: Sample 3 is similar to Sample 1 except that locking structures are processed on opposite sides of the rigid surface covering plastic material.

Sample 4: Sample 4 is similar to Sample 2 except that locking structures are processed on opposite sides of the rigid surface covering plastic material.

The stiffness of Sample 1 to Sample 4, current PVC tiles and current PVC tiles with locking structures are given in the following table.

| Samples and its thickness | | | | | | |
|---|---|---|---|---|---|---|
| (total thickness/thickness | | stiffness | | | | Shore |
| of surface protection | | | sagging | | Density | hardness |
| layer) (mm) | | time | distance | | g/cm³ | (HD) |
| current PVC | 2.0~7.0/0.55 | 20 s~5 min 50 s | 100 | mm | 1.0~2.3 | 46~65 |
| tiles | | | | | | |
| current PVC | 3.2~7.0/0.55 | 20 min 45 s~1 h | 100 | mm | 1.0~2.3 | 50~68 |
| tiles with | | 48 min 38 s | | | | |
| locking | | | | | | |
| structures | | | | | | |
| Sample 1 | 2.0~7.0/0.55 | 2 h | 5~28 | mm | 1.0~2.3 | 50~85 |
| Sample 2 | 2.0~7.0/0.55 | 2 h | 13~80 | mm | 1.0~2.3 | 54~80 |
| Sample 3 | 3.2~7.0/0.55 | 2 h | 2~12 | mm | 1.0~2.3 | 60~83 |
| Sample 4 | 3.2~7.0/0.55 | 2 h | 5~36 | mm | 1.0~2.3 | 56~78 |

Test Descriptions: droop distance of 100 mm indicates the test piece touches the ground within the predetermined time, droop distance of less than 100 mm indicates the test piece does not touchdown within 2 hours.

As can be seen from the table, the present rigid surface covering plastic material basically does not droop within 2 hours at room temperature, which indicates the stiffness of the rigid surface covering plastic material of the present invention is significantly greater than that of the current available PVC tiles and the current available PVC tiles with locking structures.

In summary, the embodiments of the rigid surface covering plastic material of the present invention have the following advantages:

1. The stiffness of the rigid surface covering plastic material is significantly improved by adding solid plasticizers (a modified green plastic with a melting point of 50˜150° C. and/or EPDM) into the material mixture of the base layer and providing a reasonable formula design of the material mixture. Due to the melting points of the modified green plastic and EPDM are below a calender processing point 160˜170° C. of PVC, the fluidity of molten PVC mixture is improved, and calender molding of the molten PVC mixture is further facilitated. In a preferred embodiment of the present invention, due to the modified TPU and EPDM has strength and toughness as rubber body, the strength and toughness of the rigid surface covering plastic material are significantly improved. Furthermore, due to the modified TPU and EPDM have low glass transition temperature (the minimum glass transition temperature of modified TPU reaches −50° C., and the minimum glass transition temperature of EPDM reaches −48° C.), the glass transition temperature of the PVC mixture is effectively reduced, and the rigid surface covering plastic material obtains good low temperature performance, which makes the rigid surface covering plastic material, especially PVC tiles, overcomes low temperature embrittlement defect, so that the product surface of the PVC tiles will not crack or fracture because of temperature difference between the origin country and the export country when exported to high-latitudes countries in Europe. In addition, owing to the thermal expansion coefficient of TPU is less than PVC, the sheet formed by the PVC mixture obtains better dimensional stability.

2. The glass fiber layer arranged in the base layer could increase the toughness, reduce deformation and increase stability of the rigid surface covering plastic material.

3. The stiffness of the rigid surface covering plastic material being relative high can effectively increase the locking force of the PVC sheet, on one side makes the locking force of the present rigid surface covering plastic material be greater than the locking force of the ordinary PVC sheet when they have the same type of locking structure, on the other side makes the areas of the recesses and the projections of the present rigid surface covering plastic material be smaller than the ordinary PVC sheet in order to achieve the same locking force when they have the same type of locking structure. That is to say, the present rigid surface covering plastic material could decrease the areas of the locking structure and decreases the cost of the floor tile.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A rigid surface covering plastic material, comprising:
a base layer consisting essentially of:
PVC resin, 10 to about 60 parts by weight per 100 parts PVC resin of solid plasticizer and 60 to about 510 parts by weight per 100 parts PVC resin of additive, wherein the solid plasticizer is selected from a group consisting of a modified green plastic with a melting point of 50 to about 150° C. and EPDM (Ethylene Propylene Diene Monomer);
a decoration layer disposed on and above the base layer; and
a surface protection layer disposed on and above the decoration layer, wherein the surface protection layer is a hard PVC transparent film or a hard transparent polyester film.

2. The rigid surface covering plastic material according to claim 1, wherein the base layer further comprises 0.1 to about 10 parts by weight per 100 parts PVC resin of liquid plasticizer.

3. The rigid surface covering plastic material according to claim 1, wherein the base layer comprises 30 to about 60 parts by weight per 100 parts PVC resin of the solid plasticizer.

4. The rigid surface covering plastic material according to claim 1, wherein the modified green plastic with a melting point of 50 to about 150° C. is selected from a group consisting of modified TPU (Thermoplastic polyurethanes), modified PU (Poly urethane) and modified PP (Polypropylene).

5. The rigid surface covering plastic material according to claim 1, wherein the solid plasticizer is a modified TPU with a melting point of 120 to about 130° C.

6. The rigid surface covering plastic material according to claim 1, wherein the base layer comprises 150 to about 350 parts by weight per 100 parts PVC resin of the additives.

7. The rigid surface covering plastic material according to claim 1, wherein the base layer comprises 225 to about 300 parts by weight per 100 parts PVC resin of the additives.

8. The rigid surface covering plastic material according to claim 2, wherein the liquid plasticizer is selected from a group consisting of phthalate acid esters plasticizers, fatty acid ester plasticizers, aliphatic dibasic acid ester plasticizers, phosphate ester plasticizers, epoxy compound plasticizers, chlorine-containing plasticizers and trimellitate plasticizers.

9. The rigid surface covering plastic material according to claim 2, wherein the liquid plasticizer is DOTP (dioctyl terephthalate).

10. The rigid surface covering plastic material according to claim 1, wherein the base layer comprises a middle layer and a bottom layer, the middle layer comprises PVC resin, 10 to about 60 parts by weight per 100 parts PVC resin of solid plasticizer and 125 to about 400 parts by weight per 100 parts PVC resin of additive, the bottom layer comprises PVC resin, 10 to about 60 parts by weight per 100 parts PVC resin of solid plasticizer and 60 to about 350 parts by weight per 100 parts PVC resin of additive.

11. The rigid surface covering plastic material according to claim 10, wherein the rigid surface covering plastic material further comprises at least a glass fiber layer, which is disposed between the middle layer and the bottom layer.

12. The rigid surface covering plastic material according to claim 10, wherein the middle layer has multilayer structure, the rigid surface covering plastic material further comprises at least a glass fiber layer, which is disposed between adjacent layers of the middle layer.

13. (canceled)

14. The rigid surface covering plastic material according to claim 1, wherein a hardness of the surface protection layer is 50 to about 85 Shore D Hardness, and a thickness of the surface protection layer is 0.05 to about 1.5 mm.

15. The rigid surface covering plastic material according to claim 1, wherein a rigid surface covering plastic material sheet with a thickness of 2.0 to about 7.0 mm droops a distance of less than 100 mm within two hours at room temperature and the stiffness of the rigid surface covering plastic material is measured by the droop distance of the rigid surface covering plastic material sheet.

16. The rigid surface covering plastic material according to claim 15, wherein the dimension of the rigid surface covering plastic material sheet used for measuring the stiffness of the rigid surface covering plastic material is 457.2 mm by 50 mm, when measuring, the rigid surface covering plastic material sheet is placed on a work table of 100 mm high with a first end of 165 mm length laying on the work table and a second end extending outside the work table, the first end of the rigid surface covering plastic material sheet is pressed a length of 50 mm at a position spacing a distance of 115 mm from a corresponding terminal end of the work table.

17. A rigid surface covering plastic material, comprising:
a base layer consisting essentially of:
PVC resin, 10 to about 60 parts by weight per 100 parts PVC resin of solid plasticizer and 60 to about 510 parts by weight per 100 parts PVC resin of additive, wherein the solid plasticizer is selected from a group consisting of a modified green plastic with a melting point of 50 to about 150° C. and EPDM;
a decoration layer disposed on and above the base layer; and
a surface protection layer disposed on and above the decoration layer, and the stiffness of the rigid surface covering plastic material is indicated by a droop distance of a rigid surface covering plastic material sheet with a thickness of 2.0 to about 7.0 mm, the rigid surface covering plastic material sheet droops a distance of less than 100 mm within two hours at room temperature.

18. (canceled)

19. The rigid surface covering plastic material according to claim 17, wherein the base layer further comprises 0.1 to about 10 parts by weight per 100 parts PVC resin of liquid plasticizer.

20. (canceled)

21. The rigid surface covering plastic material according to claim 1, wherein a thickness of the base layer is 1.95 to about 6.95 mm.

22. The rigid surface covering plastic material according to claim 1, wherein the decoration layer is disposed on and contacts the base layer, and the surface protection layer is disposed on and contacts the decoration layer.
